(19) United States
(12) Patent Application Publication
(10) Pub. No.: US 2021/0351602 A1
(43) Pub. Date: Nov. 11, 2021

(54) MOBILE POWER SOURCE SHARING DEVICE AND MOBILE POWER SOURCE THEREOF

(71) Applicant: Powergene Technology Co., Ltd., Taiwan Branch, New Taipei City (TW)

(72) Inventor: Hui-Te HSU, New Taipei City (TW)

(21) Appl. No.: 16/997,826

(22) Filed: Aug. 19, 2020

(30) Foreign Application Priority Data
May 8, 2020 (TW) 109205609

(51) Int. Cl. H02J 7/00; H02J 50/10; H02J 50/90

(52) U.S. Cl. CPC H02J 7/0045; H02J 50/90; H02J 50/10

(57) ABSTRACT

A mobile power source sharing device and a mobile power source thereof are disclosed. The mobile power source sharing device includes a power supply main body having insertion slots and wireless charging modules disposed at one side of each insertion slot, and a mobile power source having a housing, a battery, a wireless receiving terminal module and a wireless transmitting terminal module. Each wireless charging module has a wireless charging coil and a control circuit board electrically connected. The mobile power source can be inserted in or removed from one of the insertion slots. When the mobile power source is inserted in one of the insertion slots, the wireless charging coil and the wireless receiving terminal module are oppositely arranged. Accordingly, the mobile power source is still provided with a charging function while running out electric energy and unable to be returned.

### BACKGROUND OF THE INVENTION

### Field of the Invention

The present invention relates to a mobile power source device, especially to a mobile power source sharing device and a mobile power source thereof.

### Description of Related Art

There is one kind of sharing-type mobile power source renting station, the mobile power source renting station is electrically connected to a plurality of mobile power sources, thereby allowing a user, who is not in his/her domestic space, to rent for charging his/her mobile power source at any time.

However, the conventional mobile power source renting station is to utilize a connector to charge the mobile power source, but the above-mentioned connector is made in a certain specification, thus a user could not charge the mobile power source by himself/herself, and the mobile power source may run out the stored electric power before the mobile power source is returned.

Accordingly, the applicant of the present invention has devoted himself for improving the mentioned disadvantages.

### SUMMARY OF THE INVENTION

The present invention is to provide a mobile power source sharing device and a mobile power source thereof, in which the mobile power source has a wireless receiving terminal module, so that the mobile power source can be provided with a charging function while running out the stored electric energy and unable to be returned, thereby increasing the operation convenience of the mobile power source.

According, the present invention provides a mobile power source sharing device, which includes: a power supply main body, having a plurality of insertion slots and a plurality of wireless charging modules disposed at one side of each of the insertion slots, wherein each of the wireless charging modules has a wireless charging coil and a control circuit board electrically connected with each other; and at least one mobile power source, capable of being inserted in or removed from one of the insertion slots and having a housing, and a battery, a wireless receiving terminal module and a wireless transmitting terminal module disposed in the housing; wherein, when the mobile power source is inserted in one of the insertion slots, the wireless charging coil and the wireless receiving terminal module are oppositely arranged.

Accordingly, the present invention provides a mobile power source, which includes: a housing; a battery disposed in the housing; a wireless receiving terminal module disposed in the housing and electrically connected to the battery; and a wireless transmitting terminal module, disposed in the housing and electrically connected to the battery.

Based on what has been disclosed above, the mobile power source has the wireless receiving terminal module, so that under a situation of the mobile power source is about to run out the stored electric energy and unable to be returned, the mobile power source is still provided with a charging function while running out the stored electric energy and unable to be returned.

### BRIEF DESCRIPTION OF DRAWINGS

FIG. 1 is a perspective exploded view showing a mobile power source sharing device according to the present invention;

FIG. 2 is a schematic view showing an operating status of the mobile power source sharing device according to the present invention;

FIG. 3 is a perspective view showing the assembly of the mobile power source sharing device according to the present invention;

FIG. 4 is a schematic view showing another operating status of the mobile power source sharing device according to the present invention; and

FIG. 5 is a cross sectional view showing the mobile power source sharing device according to another embodiment of the present invention.

### DETAILED DESCRIPTION OF THE INVENTION

Preferred embodiments of the present invention will be described with reference to the drawings.

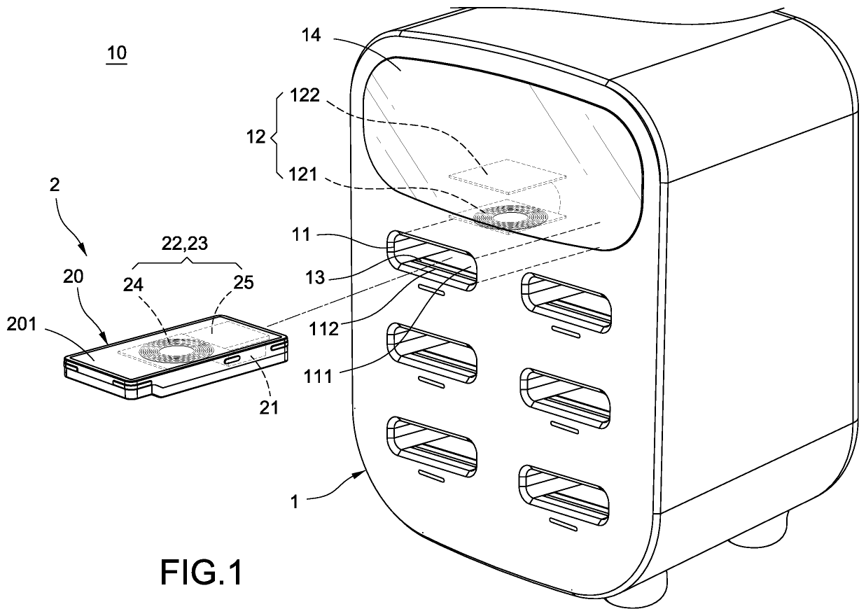

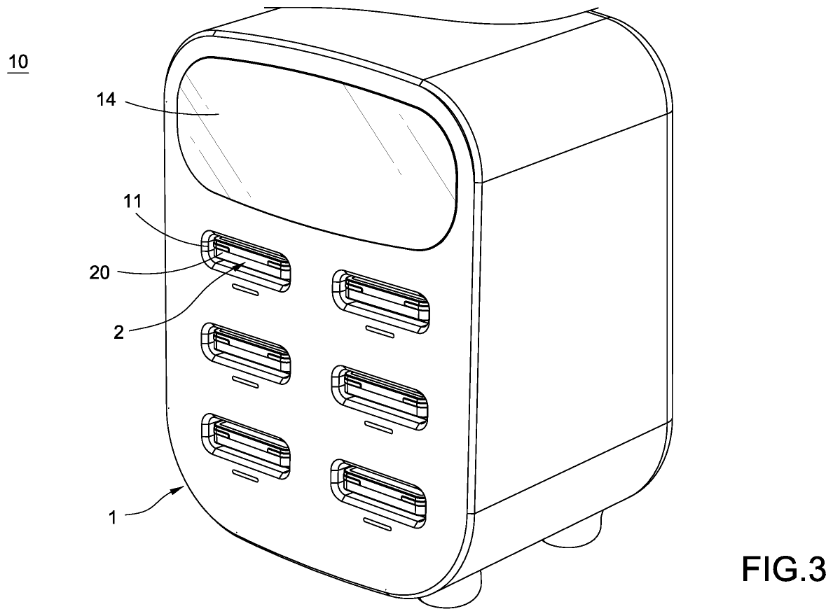

Please refer from FIG. 1 to FIG. 4, the present invention provides a mobile power source sharing device and a mobile power source thereof. The mobile power source sharing device 10 mainly includes a power supply main body 1 and one or a plurality of mobile power sources 2.

As shown from FIG.1 to FIG. 4, the power supply main body 1 has a plurality of insertion slots 11 and a plurality of wireless charging modules 12 disposed at one side of each of the insertion slots 11, each of the wireless charging modules 12 has a wireless charging coil 121 and a control circuit board 122 electrically connected with each other.

Moreover, a recess 112 is formed on a bottom wall 111 of each of the insertion slots 11, the power supply main body 1 further has a plurality of ascending block members 13 disposed in each of the recesses 112, and each of the ascending block members 13 is able to be ascended or descended relative to each of the bottom walls 111.

As shown from FIG. 1 to FIG. 4, the mobile power source 2 can be inserted in or removed from anyone of the insertion slots 11, the mobile power source 2 has a housing 20, a battery 21 disposed inside the housing 21, a wireless receiving terminal (RX) module 22 and a wireless transmitting terminal (TX) module 23.

According to this embodiment, the wireless receiving terminal module 22 and the wireless transmitting terminal module 23 are integrated as one piece, the wireless receiving terminal module 22 and the wireless transmitting terminal module 23 are together provided with a composite sensing coil 24 and a circuit board 25 electrically connected with each other, a part of the composite sensing coil 24 is defined as a transmitting end sensing coil and another part thereof is defined as a receiving end sensing coil, and the composite sensing coil 24 and the wireless charging coil 121 are oppositely arranged.

Details are provided as follows. The composite sensing coil 24 is divided into an inner circular part defined from an inner side to a central location and an outer circular part defined from an outer side to the central location, one of the inner circular part and the outer circular part of the composite sensing coil 24 is formed as the transmitting end sensing coil, and the other thereof is formed as the receiving end sensing coil.

When the mobile power source 2 is inserted in the insertion slot 11, the wireless charging coil 121 and the composite sensing coil 24 are oppositely arranged; according to this embodiment, each of the wireless charging coils 121 is disposed above each of the insertion slots 11, and the composite sensing coil 24 is arranged on a top portion 201 of the housing 20 for being matched with the wireless charging coil 121, but what shall be addressed is that the scope of the present invention is not limited to the above-mentioned arrangement.

The power supply main body 1 further has a control screen 14, thus a user can control the ascending block member 13 to be ascended or descended relative to the bottom wall 111 and the mobile power source 2 to be retracted for being removed from the insertion slot 11 through operating the control screen 14.

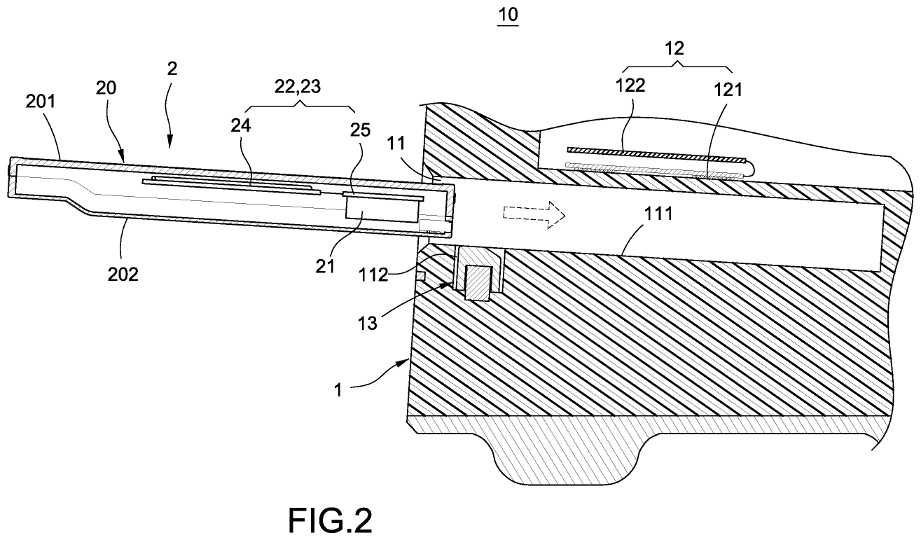

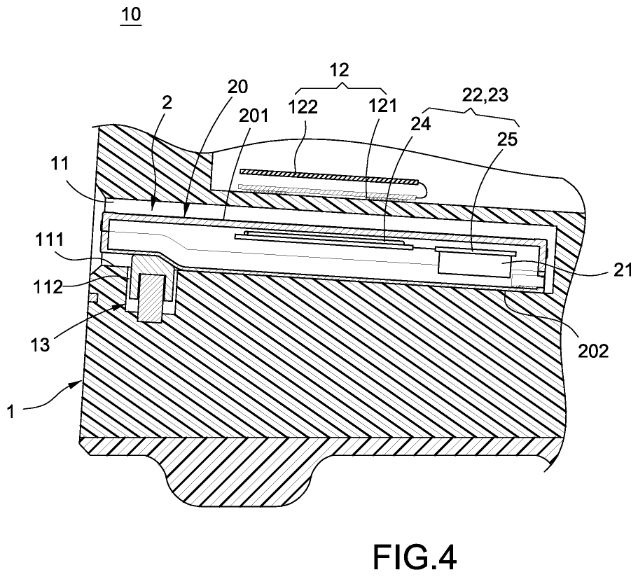

As shown from FIG. 1 to FIG. 4, wherein FIG. 2 and FIG. 4 are schematic views showing operating statuses of the mobile power source sharing device 10 and the mobile power device 2 according to the present invention; the mobile power source 2 is inserted in anyone of the insertion slots 11, the wireless charging coil 121 and the wireless receiving terminal module 22 are oppositely arranged, the wireless charging coil 121 is used for transmitting wireless power under a principle of electromagnetic inducting theory, so that magnetic force lines and an alternating magnetic field can be generated though an electric current passing the wireless charging coil 121, the alternating magnetic field is sensed by the receiving end sensing coil of the composite sensing coil 24 of the wireless receiving terminal module 22 so as to be converted into alternative-current electric power, then the alternative-current electric power is stored in the battery 21 by being controlled by the circuit board 25, thereby achieving a charging step supplied by the mobile power source sharing device 10 to the mobile power source 2.

Moreover, when the mobile power source 2 is inserted in anyone of the insertion slots 11, the ascending block member 13 can be ascended relative to the bottom wall 111 for blocking the mobile power source 2, so that the mobile power source 2 is able to be stably positioned in the insertion slot 11 via the ascending block member 13.

After the mobile power source 2 is removed through the user operating the control screen 14, the electric current is controlled by the circuit board 25 of the wireless transmitting terminal module 23 to pass the transmitting end sensing coil of the composite sensing coil 24 for generating magnetic force lines and an alternating magnetic field, so that the wireless transmitting terminal module 23 can be used for charging an electronic device having a wireless charging function, thereby achieving an objective of charging the mobile power source 2 at anytime and anywhere.

Moreover, the mobile power source 2 has the wireless receiving terminal module 22, under a situation of the mobile power source 2 is about to run out the stored electric energy and unable to be returned, an external wireless charging device can still be used for charging the mobile power source 2 via the wireless receiving terminal module 22, so that the mobile power source 2 is provided with a charging function while running out the stored electric energy and unable to be returned, thereby increasing the operation convenience of the mobile power source 2.

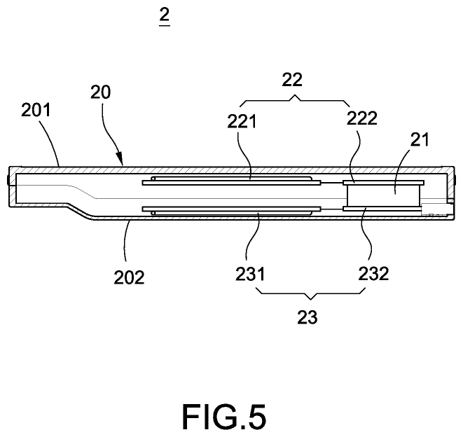

Please refer to FIG. 5, which discloses another embodiment of the mobile power source 2 provided by the present invention; the another embodiment disclosed in FIG. 5 is substantially the same as the embodiment disclosed from FIG. 1 to FIG. 4, a difference between the another embodiment disclosed in FIG. 5 and the embodiment disclosed from FIG. 1 to FIG. 4 is that the wireless receiving terminal module 22 and the wireless transmitting terminal module 23 are two individual components.

The wireless receiving terminal module 22 has a receiving end sensing coil 221 and a first circuit board 22 electrically connected with each other, the wireless transmitting terminal module 23 has a transmitting end sensing coil 231 and a second circuit board 232 electrically connected with each other, and the receiving end sensing coil 221 and the wireless charging coil 121 are oppositely arranged. Accordingly, same effects achieved by the embodiment disclosed from FIG. 1 to FIG. 4 can be provided.

Details are provided as follows. When the mobile power source 2 is inserted in anyone of the insertion slots 11, the wireless charging coil 121 and the wireless receiving terminal module 22 are oppositely arranged, the wireless charging coil 121 is used for transmitting the wireless power under the principle of electromagnetic inducting theory, so that the magnetic force lines and the alternating magnetic field can be generated though the electric current passing the wireless charging coil 121, the alternating magnetic field is sensed by the receiving end sensing coil 221 of the wireless receiving terminal module 22 so as to be converted into the alternative-current electric power, then the alternative-current electric power is stored in the battery 21 by being controlled by the first circuit board 222, thereby achieving the charging step supplied by the mobile power source sharing device 10 to the mobile power source 2.

The electric current is controlled by the second circuit board 232 of the wireless transmitting end sensing coil 231 for generating magnetic force lines and an alternating magnetic field, so that the wireless transmitting terminal module 23 can be used for charging the electronic device having a wireless charging function, thereby achieving an objective of charging the mobile power source 2 at anytime and anywhere.

When the mobile power source 2 is inserted in the insertion slot 11, the wireless charging coil 121 and the receiving end sensing coil 221 are oppositely arranged; according to this embodiment, each of the wireless charging coils 121 is disposed above each of the insertion slots 11, the receiving end sensing coil 221 is arranged on the top portion 201 of the housing 20 for being matched with the wireless charging coil 121, and the transmitting end sensing coil 231 is arranged on a bottom portion 202 of the housing 20, but what shall be addressed is that the scope of the present invention is not limited to the above-mentioned arrangement.

Although the present invention has been described with reference to the foregoing preferred embodiment, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

What is claimed is:

1. A mobile power source sharing device, including:
an a power supply main body, having a plurality of insertion slots and a plurality of wireless charging modules disposed at one side of each of the insertion slots, wherein each of the wireless charging modules has a wireless charging coil and a control circuit board electrically connected with each other; and
at least one mobile power source, capable of being inserted in or removed from one of the insertion slots and having a housing, and a battery, a wireless receiving terminal module and a wireless transmitting terminal module disposed in the housing;
wherein, when the mobile power source is inserted in one of the insertion slots, the wireless charging coil and the wireless receiving terminal module are oppositely arranged.

2. The mobile power source sharing device according to claim 1, wherein a recess is formed on a bottom wall of each of the insertion slots, the power supply main body further has a plurality of ascending block members disposed in each of the recesses, and each of the ascending block members is able to be ascended or descended relative to each of the bottom walls for blocking the mobile power source.

3. The mobile power source sharing device according to claim 2, wherein the wireless receiving terminal module and the wireless transmitting terminal module are together provided with a composite sensing coil and a circuit board electrically connected with each other, a part of the composite sensing coil is defined as a transmitting end sensing coil and another part thereof is defined as a receiving end sensing coil, and the composite sensing coil and the wireless charging coil are oppositely arranged.

4. The mobile power source sharing device according to claim 3, wherein each of the wireless charging coils is disposed above each of the insertion slots, and the composite sensing coil is arranged on a top portion of the housing.

5. The mobile power source sharing device according to claim 2, wherein the wireless receiving terminal module has a receiving end sensing coil and a first circuit board electrically connected with each other, the wireless transmitting terminal module has a transmitting end sensing coil and a second circuit board electrically connected with each other, and the receiving end sensing coil and the wireless charging coil are oppositely arranged.

6. The mobile power source sharing device according to claim 5, wherein each of the wireless charging coils is disposed above each of the insertion slots, the receiving end sensing coil is arranged on a top portion of the housing, and the transmitting end sensing coil is arranged on a bottom portion of the housing.

7. The mobile power source sharing device according to claim 1, wherein the power supply main body further has a control screen.

8. A mobile power source, including:
a housing;
a battery disposed in the housing;
a wireless receiving terminal module, disposed in the housing and electrically connected to the battery; and
a wireless transmitting terminal module, disposed in the housing and electrically connected to the battery.

9. The mobile power source according to claim 8, wherein the wireless receiving terminal module and the wireless transmitting terminal module are together provided with a composite sensing coil and a circuit board electrically connected with each other, a part of the composite sensing coil is defined as a transmitting end sensing coil and another part thereof is defined as a receiving end sensing coil, and the composite sensing coil is arranged on a top portion of the housing.

10. The mobile power source according to claim 8, wherein the wireless receiving terminal module has a receiving end sensing coil and a first circuit board electrically connected with each other, the wireless transmitting terminal module has a transmitting end sensing coil and a second circuit board electrically connected with each other, the receiving end sensing coil is arranged on a top portion of the housing, and the transmitting end sensing coil is arranged on a bottom portion of the housing.
